(19) United States
(12) Patent Application Publication
(10) Pub. No.: US 2019/0291878 A1
(43) Pub. Date: Sep. 26, 2019

(54) PERIODIC HEATING FOR ELECTRIC ICE PROTECTION

(71) Applicant: ROHR, INC., Chula Vista, CA (US)

(72) Inventors: Steven M. Kestler, Winchester, CA (US); Jeffrey Harasha, Del Mar, CA (US)

(73) Assignee: ROHR, INC., Chula Vista, CA (US)

(21) Appl. No.: 15/928,467

(22) Filed: Mar. 22, 2018

(51) Int. Cl. B64D 15/12; H05B 3/26; B64D 33/02

(52) U.S. Cl. CPC B64D 15/12; B64D 2033/0233; B64D 33/02; H05B 3/262

(57) ABSTRACT

An anti-icing system for an aircraft surface is disclosed. In various embodiments, the anti-icing system includes, a plurality of conductive heating elements distributed about and in contact with the surface and a signal source configured to activate and deactivate an alternating current supplied to each one of the plurality of conductive heating elements in an ordered pattern.

### FIELD

The present disclosure relates to anti-icing systems and, more particularly, to electrically powered anti-icing systems for aircraft nacelle noselips and other aerodynamic surfaces.

### BACKGROUND

Forward facing aerodynamic surfaces on aircraft may be subject to the formation of ice when exposed to icing conditions, such as, for example, a combination of low temperature and high humidity. Such surfaces include the leading edges on wings and stabilizers and the noselips on nacelle inlets. The formation of ice on such aerodynamic surfaces may have an adverse effect upon the performance of the aircraft. For example, the formation of ice on a noselip can modify the aerodynamic properties of the nacelle inlet and disturb the flow of air toward the fan. In addition, the formation of ice on the noselip may bring about ingestion of ice into the engine, potentially damaging the engine. As such, various ice protection systems have been developed to prevent or reduce the formation of ice upon select aerodynamic surfaces. In this regard, ice protection systems may heat a leading edge or other aerodynamic surface to a temperature above that suitable for ice formation in order to prevent or reduce ice formation. In addition, conventional ice protection systems typically use higher power than is necessary for ice prevention due to power density requirements imposed by manufacturers of engines and airframes, resulting in heavy, expensive and energy inefficient systems.

### SUMMARY

An anti-icing system for an aerodynamic surface is disclosed. In various embodiments, the anti-icing system includes a plurality of conductive heating elements distributed about and in contact with the aerodynamic surface and a signal source configured to activate and deactivate an alternating current supplied to each one of the plurality of conductive heating elements in an ordered pattern.

In various embodiments, each one of the plurality of conductive heating elements is activated for a specific time period. In various embodiments, the specified time period is within a range from about 20 KHz to about 30 KHz. In various embodiments, the alternating current has a frequency within a frequency range from about 300 Hz to about 500 Hz. In various embodiments, the alternating current provides a power density within a range from about 10 KW/m² to about 50 KW/m². In various embodiments, the anti-icing system further includes a controller configured to select one or more of the specified time period, the frequency and the power density or voltage. In various embodiments, each one of the plurality of heating elements comprises a resistive material connected to an interior surface of an aircraft noselip. In various embodiments, the signal source is configured to provide one or more of a variable current, a pulsating current and an alternating current. In various embodiments, the aerodynamic surface is an aircraft noselip and the ordered pattern is a circular pattern. In various embodiments, the ordered pattern is a diagonal pattern.

A method of anti-icing an aircraft nacelle inlet having a plurality of conductive heating elements distributed about a noselip is disclosed. In various embodiments, the method includes activating and deactivating an alternating current supplied to each one of the plurality of conductive heating elements in an ordered pattern. In various embodiments, the method includes activating each one of the plurality of conductive heating elements for a specific time period. In various embodiments, the specified time period is within a range from about 20 KHz to about 30 KHz. In various embodiments, the alternating current has a frequency within a frequency range from about 300 Hz to about 500 Hz. In various embodiments, the alternating current provides a power density within a range from about 10 KW/m² to about 50 KW/m². In various embodiments, the ordered pattern is a circular pattern. In various embodiments, the ordered pattern is a diagonal pattern.

An anti-icing system for an aircraft nacelle is disclosed. In various embodiments, the anti-icing system includes a noselip and a conductive heating element distributed circumferentially about and in contact with the noselip, the conductive heating element having a first end connected to a ground and a second end connected to a signal source configured to provide an alternating current. In various embodiments, the alternating current has a frequency within a frequency range from about 300 Hz to about 500 Hz. In various embodiments, the alternating current provides a power density within a range from about 10 KW/m² to about 50 KW/m².

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 is a perspective view of a gas turbine engine nacelle for an aircraft, in accordance with various embodiments;

FIG. 2 is a cross sectional schematic view of a nacelle inlet noselip having a heating element, in accordance with various embodiments;

FIGS. 3A-3C are frontal schematic views of a nacelle noselip having heating element configurations, in accordance with various embodiments;

FIG. 4 is a block diagram of a nacelle inlet noselip heating system, in accordance with various embodiments;

FIGS. 5A and 5B depict temperature versus time plots illustrating the temperature rise to steady state of a portion of a noselip adjacent a heating element, in accordance with various embodiments; and

FIG. 6 is a frontal schematic view of a nacelle noselip having a heating element configuration, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

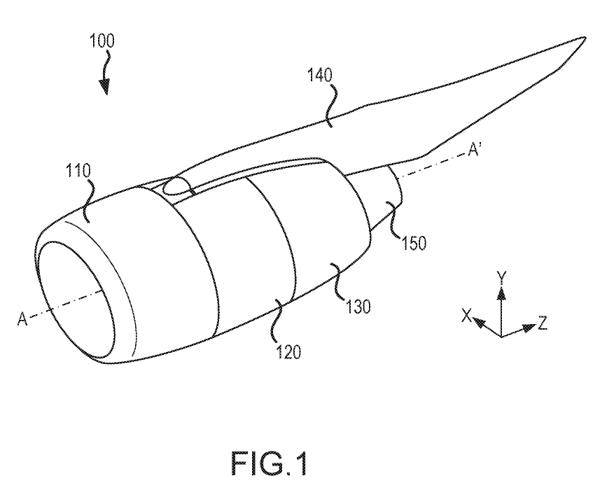

With reference to FIG. 1, a nacelle 100 for a gas turbine engine is illustrated according to various embodiments. The nacelle 100 may be suitable for an aircraft and comprise an inlet 110, a fan cowl 120 and a thrust reverser 130. The fan cowl 120 may comprise two halves pivotally mounted to a pylon 140 via one or more hinges. In this regard, the fan cowl 120 may comprise a first fan cowl (also referred to as a right-hand (RH) fan cowl) and a second fan cowl (also referred to as a left-hand (LH) fan cowl). The nacelle 100 may also define a centerline A-A′. In various embodiments, an exhaust nozzle 150 may extend from a turbine engine mounted within the nacelle 100. The nacelle 100 may be coupled to the pylon 140, which may mount the nacelle 100 to an aircraft wing or aircraft body.

Under certain operating or environmental conditions, ice formation may occur on the inlet 110. In various embodiments, an electric heater may be provided at various locations within or adjacent to the inlet 110 in order to reduce the incidence of ice formation (anti-icing). For example, in various embodiments, the electric heater may be positioned between composite layers that make up the inlet 110 or on the inner surfaces comprised by the inlet 110. While the following disclosure is directed toward various embodiments concerning anti-icing of an aircraft nacelle inlet, the disclosure contemplates the various embodiments as being applicable to anti-icing other portions of the aircraft, such as the leading edges of the wings and the stabilizer, as well as other unrelated technologies, such as the blades and various other components of wind turbines.

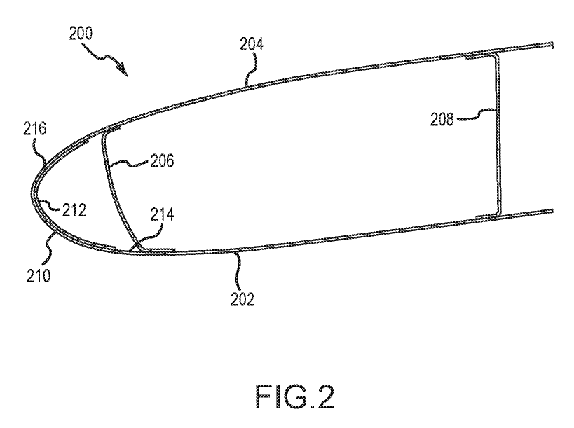

Referring now to FIG. 2, a cross-sectional view of a nacelle inlet 200 is illustrated, in accordance with various embodiments. The nacelle inlet 200 may comprise an inner barrel 202, an outer barrel 204, a forward bulkhead 206, an aft bulkhead 208 and a nose lip 210. The inner barrel 202 may be disposed radially inward from the outer barrel 204. In this regard, the outer barrel 204 may encompass the inner barrel 202. The outer barrel 204 may comprise a generally cylindrical panel. Similarly, the inner barrel 202 may comprise a generally cylindrical panel. The forward bulkhead 206 may be coupled between the inner barrel 202, the nose lip 210 and the outer barrel 204. The aft bulkhead 208 may also be coupled between the inner barrel 202 and the outer barrel 204. The outer barrel 204, the inner barrel 202, the forward bulkhead 206 and the aft bulkhead 208 may define an interior cavity having an annular geometry. Similarly, the nose lip 210 and the forward bulkhead 206 may define a nose lip cavity having an annular geometry. The nose lip 210 may also define a leading edge of the nacelle inlet 200. In various embodiments, a heating element 212 or plurality of heating elements may be positioned on an interior surface 214 of or within the nose lip 210 to heat the material comprising the nose lip 210 and reduce the incidence of ice formation occurring on an exterior surface 216 of the nose lip 210.

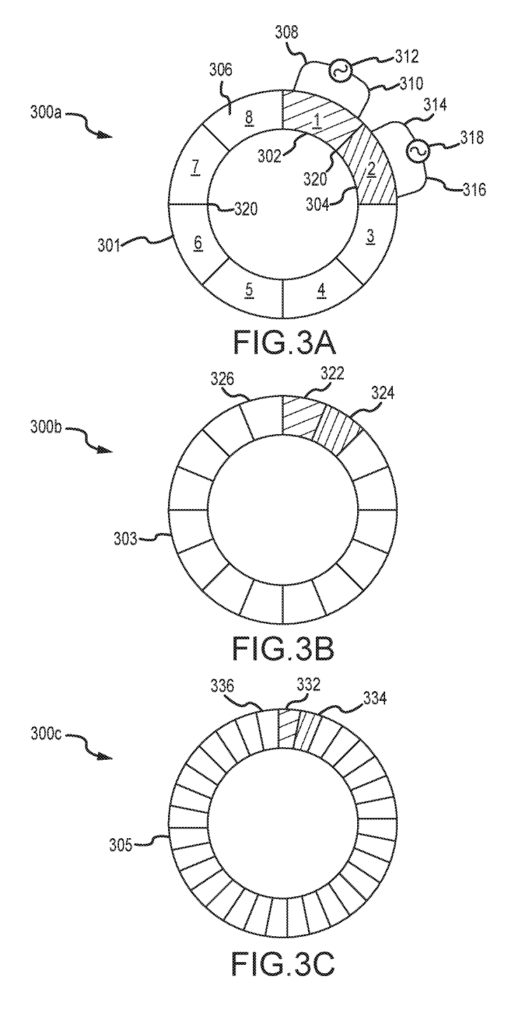

Referring now to FIGS. 3A, 3B, and 3C, frontal schematic views of a nacelle noselip having pluralities of heating element configurations, in accordance with various embodiments, are illustrated. Referring to FIG. 3A, a first noselip heating system 300a, in accordance with various embodiments, is illustrated having noselip 301 and a plurality of N=8 heating elements distributed about the noselip 301. For example, a first heating element 302 is illustrated extending from zero degrees (0°) to forty-five degrees (45°) and a second heating 304 element is illustrated extending from forty-five degrees (45°) to ninety degrees (90°). The other six heating elements are similarly distributed about the noselip 301, ending with an N-th heating element 306 (N=8) positioned adjacent to the first heating element 302.

As will be described in additional detail below, the first noselip heating system 300a operates by periodically directing an alternating current to each of the plurality of N=8 heating elements. In various embodiments, for example, the first heating element 302 includes a first power lead 308 and a second power lead 310 connected to a first alternating current signal source 312. Similarly, the second heating element 304 includes a third power lead 314 and a fourth power lead 316 connected to a second alternating current signal source 318. In various embodiments, the first alternating current signal source 312 and the second alternating current signal source 318 may be configured to provide variable currents, pulsating currents or alternating currents in the form of sine waves, square waves or triangular waves. Both the first heating element 302 and the second heating element 304 are conductors or resistive heating elements and are separated by an insulator 320. In various embodiments, the insulator 320 is a strip of non-conductive material. In various embodiments, the insulator 320 is a gap between adjacent heating elements. In various embodiments, each of the heating elements is activated (or powered), individually and singularly, for a time period T₁, and then deactivated (or depowered), such that only a single heating element is powered at any time. For example, the first heating element 302 is activated by the first alternating current signal source 312 for a first duration of time (0<t≤T₁). During the first duration of time, each of the other heating elements is inactive—i.e., there is no power provided to the other heating elements during the first duration of time (0<t≤T₁). During a second duration of time (T<t≤2T₁), the second heating element 304 is activated, while each of the other heating elements, including the first heating element 302, is inactive. The process continues until each one of the plurality of heating elements is, individually and singularly, activated and deactivated (or powered and depowered). Following the activation and deactivation of each of the N heating elements (e.g., at t=8T₁), the process repeats, in an ordered pattern, as above described, or in some other predetermined pattern, such that each of the N heating elements is activated and deactivated during any duration of time equal to the number of heating elements, N, times the time period, T₁.

In various embodiments, the ordered pattern is circular, such that each of the heating elements is activated and deactivated in a clockwise or counterclockwise direction. For the N=8 configuration illustrated in FIG. 3A, for example, where each of the heating elements (RE) is numbered consecutively from 1 to 8 around the noselip, the circular pattern of activating and deactivating each of the heating elements in the clockwise direction is HE, =1, 2 . . . 8. In various embodiments, the ordered pattern is diagonal, such that each of the heating elements is activated in a diagonal pattern that rotates about the center of the noselip. For the N=8 configuration, for example, the diagonal pattern of activating and deactivating each of the heating elements in the clockwise direction is HE, =1, 5, 2, 6, 3, 7, 4, 8. Similarly, a staggered pattern of activating and deactivating each of the heating elements in the clockwise direction for the N=8 case may be HE, =1, 3, 5, 7, 2, 4, 6, 8. The disclosure contemplates any other ordered pattern of repeatedly cycling through the N heating elements, so long as the ordered pattern is repeated during each cycle.

Referring now to FIGS. 3B and 3C, two further embodiments of nose lip heating systems are illustrated. For example, in FIG. 3B, a second noselip heating system 300b is illustrated having a noselip 303 and a plurality of N=16 heating elements arranged about the noselip 303, while in FIG. 3C, a third noselip heating system 300c is illustrated having a noselip 305 and a plurality of N=32 heating elements arranged about the noselip 305. Similar to the description above with reference to FIG. 3A, the second noselip heating system 300b includes a first heating element 322 extending from zero degrees (0°) to twenty-two and one-half degrees (22.5°) and a second heating 324 element extending from twenty-two and one-half degrees (22.5°) to forty-five degrees (45°). The other fourteen heating elements are similarly distributed about the noselip 303, ending with an N-th heating element 326 (N=16) positioned adjacent to the first heating element 322. Likewise, the third noselip heating system 300c includes a first heating element 332 extending from zero degrees (0°) to eleven and one-quarter degrees (11.25°) and a second heating 334 element extending from eleven and one-quarter degrees (11.25°) to twenty-two and one-half degrees (22.5°). The other thirty heating elements are similarly distributed about the noselip 305, ending with an N-th heating element 336 (N=32) positioned adjacent to the first heating element 332.

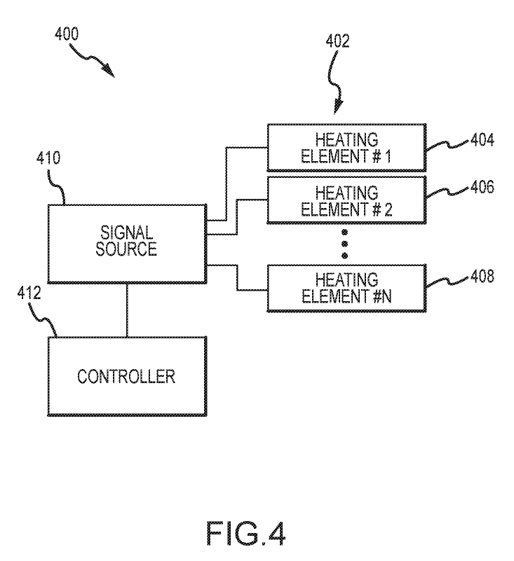

Referring now to FIG. 4, a block diagram of a noselip heating system 400 is illustrated, in accordance with various embodiments. The noselip heating system may include a plurality of heating elements 402, including a first heating element 404, a second heating element 406 . . . and an N-th heating element 408. In various embodiments, the plurality of heating elements 402 is spaced regularly about a nacelle noselip, similar to embodiments above described with reference to FIGS. 3A-3C. The noselip heating system 400 may further include a signal source 410 and a controller 412. In various embodiments, the signal source 410 is configured to provide an alternating current in the form of a sine wave. The signal source 410 may also be configured to provide variable currents, pulsating currents or alternating currents in the form a square waves or triangular waves. In various embodiments, the signal source 410 is configured to provide an alternating current in the form of a sine wave, having a frequency within a range from about 200 Hz to about 600 Hz; in various embodiments, the signal source 410 is configured to provide an alternating current in the form of a sine wave, having a frequency within a range from about 300 Hz to about 500 Hz; and in various embodiments, the signal source 410 is configured to provide an alternating current in the form of a sine wave, having a frequency equal to about 400 Hz. In various embodiments, the signal source is configured to provide alternating current at a frequency selected based upon the number N of heating elements regularly spaced about the noselip, thereby facilitating efficient heating of the resistive heating elements based on their individual size and shape and the materials used in their construction. In various embodiments, the signal source 410 is configured to generate an alternating current that provides a power density within a range from about 1 KW/m² to about 100 KW/m² (kilowatts/square meter); and in various embodiments, the signal source 410 is configured to generate an alternating current that provides a power density within a range from about 10 KW/m² to about 50 KW/m². In each of the ranges provided above, the disclosure contemplates a tolerance of plus or minus ten percent (10%) at the extremes of each of the ranges.

Still referring to FIG. 4, the controller 412 may be configured to direct the signal source to the individual heating elements of the plurality of heating elements 402 at select, predetermined times. In various embodiments, the controller 412 is configured to direct the signal source to the individual heating elements in a circular fashion, such as, for example, in a clockwise or counterclockwise direction around the noselip. In various embodiments, the controller 412 is configured to direct the signal source to activate and deactivate each of the heating elements for a specified time period, T. In various embodiments, the controller 412 is configured to activate and deactivate each of the heating elements at a frequency in the range of about 10 KHz to about 40 KHz; in various embodiments, the controller 412 is configured to activate and deactivate each of the heating elements at a frequency in the range of about 20 KHz to about 30 KHz; and in various embodiments, the controller 412 is configured to activate and deactivate each of the heating elements at a frequency equal to about 25 KHz. In various embodiments, the controller 412 is configured to activate and deactivate the individual heating elements at a frequency such that the temperature of the noselip adjacent to each heating element increases in a logarithmical fashion, eventually reaching a steady state, as explained further below.

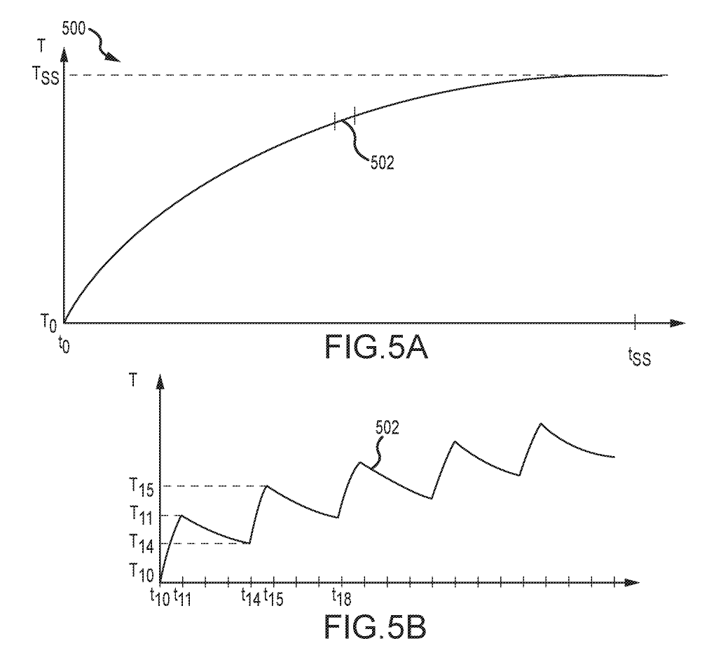

Referring now to FIGS. 5A and 5B, temperature versus time plots illustrating the temperature rise to steady state (or near steady state) of a portion of a noselip adjacent to a heating element are provided, in accordance with various embodiments. Referring to FIG. 5A, for example, the temperature of the noselip adjacent to a heating element is illustrated in a temperature versus time plot 500 rising from an initial temperature T₀, at time t₀, which is the time the heating system is turned on, to a steady temperature T_{SS}, at time t_{SS}. A controller, such as the controller 412 described above with reference to FIG. 4, is configured to heat the noselip to the steady temperature T_{SS}, which is above the freezing temperature of water.

Referring to FIG. 5B, an expanded portion 502 of the temperature versus time plot 500 shown in FIG. 5A is illustrated. The expanded portion 502 illustrates the temperature versus time behavior of a noselip heating system having four heating elements (N=4)—e.g., a first, a second, a third and a fourth heating element positioned circumferentially about the noselip similar to the embodiments described above with reference to FIGS. 3A-3C. In accordance with various embodiments, the first heating element is activated at t₁₀ and deactivated at t₁₁, causing a rise in temperature of the noselip adjacent to the first heating element from T₁₀ to T₁₁, or ΔT_{R1}. During the time duration from t₁₁ to t₁₄, the second, third and fourth heating elements are similarly activated and deactivated, causing similar temperature rises of the noselip adjacent to the respective second, third and fourth heating elements. During the same time duration, from t₁₁ to t₁₄, the temperature of the noselip adjacent to the first heating element falls from T₁₁ to T₁₄, or ΔT_{F1}. The first heating element is again activated at t₁₄ and deactivated at t₁₅, causing a rise in temperature of the noselip adjacent to the first heating element from T₁₄ to T₁₅, or ΔT_{R2}. During the time duration from t₁₅ to t₁₈, the second, third and fourth heating elements are similarly again activated and deactivated, causing similar temperature rises of the noselip adjacent to the respective second, third and fourth heating elements. During the same time duration, from t₁₅ to t₁₈, the temperature of the noselip adjacent to the first heating element falls from T₁₁ to T₁₄, or ΔT_{F2}. During the rise in temperature to the steady state temperature T_{SS}, the rise in temperature ΔT_{R1} will be greater than ΔT_{R2}. Similarly, the fall in temperature ΔT_{F1} will be greater than ΔT_{F2}. At steady state, ΔT_{R1} will essentially equal ΔT_{R2}, with both approaching zero, and ΔT_{F1} will essentially equal ΔT_{F2}, with both also approaching zero, thereby enabling the noselip heating system to provide continuous anti-icing at low power levels.

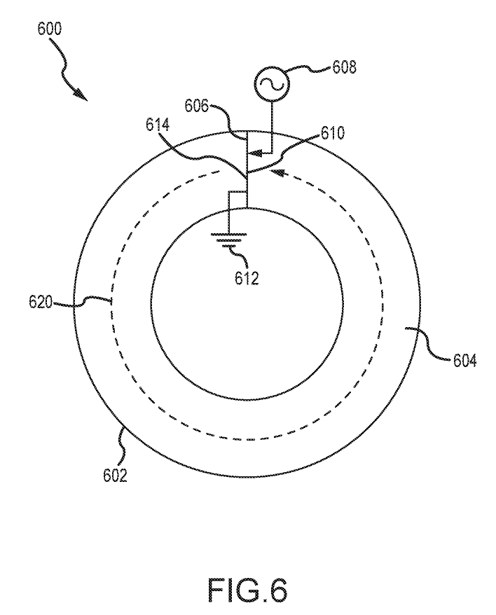

Referring now to FIG. 6, a noselip heating system 600, in accordance with various embodiments, is illustrated having noselip 602 and a single heating element 604 extending about the noselip 602. An insulator 606 is positioned at zero degrees (0°) and the single heating element 604 extends about the noselip 602 from zero degrees (0°) to three hundred sixty degrees (360°). A signal generator 608 is connected to the single heating element 604 on a first side 610 of the insulator 606 and a ground 612 is connected to the single heating element 604 on a second side 614 of the insulator 606. In various embodiments, a flow of alternating current 620 is established about the single heating element in response to the signal generator 608. A controller, such as the controller described above with reference to FIG. 4, may be used to activate and deactivate power to the single heating element 604 and adjust the power density or voltage input. In various embodiments, the signal generator 608 runs continuously toward a steady state temperature distribution around the noselip 602 and, notwithstanding a single heating element 604 (N=1) is employed, a heating response from the flow of alternating current 620 continuously flowing about the noselip 602 is representative of an embodiment having an infinite number of heating elements (N=∞) distributed about the noselip 602.

The above disclosure provides systems and methods of maintaining an aerodynamic surface free of ice using a low peak power throughout the system's use. As described, and in accordance with various embodiments, the systems work by activating and deactivating heating elements positioned adjacent to a noselip periodically at high frequencies to reduce the incidence of ice formation, as opposed to removing the ice following formation. By periodically powering the heating elements at a high frequency one is able to heat small sections of the noselip at such a high rate that before power returns to that section of the noselip, the section has not lost the thermal energy previously supplied. Therefore, by adding more thermal energy to the noselip section, one may further increase the temperature of the section until a steady state is reached. The systems are also self-regulating as the temperature increase of each section of a noselip with each powering period will be smaller and smaller as the temperature increases toward steady state. The above described systems will also allow anti-icing ice protection to be performed with a low peak power, allowing for the implementation of an electric ice protection system without having to add heavy or costly generators to currently existing system architectures.

Finally, it should be understood that any of the above described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An anti-icing system for an aerodynamic surface, comprising:
a plurality of conductive heating elements distributed about and in contact with the aerodynamic surface; and
a signal source configured to activate and deactivate an alternating current supplied to each one of the plurality of conductive heating elements in an ordered pattern.

2. The anti-icing system of claim 1, wherein each one of the plurality of conductive heating elements is activated for a specific time period.

3. The anti-icing system of claim 2, wherein the specific time period is within a range from about 20 KHz to about 30 KHz.

4. The anti-icing system of claim 3, wherein the aerodynamic surface is an aircraft noselip and the ordered pattern is a circular pattern.

5. The anti-icing system of claim 3, wherein the aerodynamic surface is an aircraft noselip and the ordered pattern is a diagonal pattern.

6. The anti-icing system of claim 3, wherein the alternating current has a frequency within a frequency range from about 300 Hz to about 500 Hz.

7. The anti-icing system of claim 6, wherein the alternating current provides a power density within a range from about 10 KW/m² to about 50 KW/m².

8. The anti-icing system of claim 7, wherein each one of the plurality of heating elements comprises a resistive material connected to an interior surface of an aircraft noselip.

9. The anti-icing system of claim 3, wherein the signal source is configured to provide one or more of a variable current, a pulsating current and an alternating current.

10. The anti-icing system of claim 7, further comprising a controller configured to select one or more of the specific time period, the frequency, the power density and a voltage.

11. A method of anti-icing an aircraft nacelle inlet having a plurality of conductive heating elements distributed about a noselip, comprising:
activating and deactivating an alternating current supplied to each one of the plurality of conductive heating elements in an ordered pattern.

12. The method of claim 11, further comprising activating each one of the plurality of conductive heating elements for a specific time period.

13. The method of claim 12, wherein the specific time period is within a range from about 20 KHz to about 30 KHz.

14. The method of claim 13, wherein the ordered pattern is a circular pattern.

15. The method of claim 13, wherein the ordered pattern is a diagonal pattern.

16. The method of claim 13, wherein the alternating current has a frequency within a frequency range from about 300 Hz to about 500 Hz.

17. The method of claim 16, wherein the alternating current provides a power density within a range from about 10 KW/m² to about 50 KW/m².

18. An anti-icing system for an aircraft nacelle, comprising:
a noselip; and
a conductive heating element distributed circumferentially about and in contact with the noselip, the conductive heating element having a first end connected to a ground and a second end connected to a signal source configured to provide an alternating current.

19. The anti-icing system of claim 18, wherein the alternating current has a frequency within a frequency range from about 300 Hz to about 500 Hz.

20. The anti-icing system of claim 19, wherein the alternating current provides a power density within a range from about 10 KW/m² to about 50 KW/m².
